(19) United States
(12) Patent Application Publication
(10) Pub. No.: US 2022/0214678 A1
(43) Pub. Date: Jul. 7, 2022

(54) METHOD FOR OPTIMIZING AND CATEGORIZING EQUIPMENT DIAGNOSTIC MESSAGES

(71) Applicant: PHILLIPS 66 COMPANY, HOUSTON, TX (US)

(72) Inventors: Denis I. Tzerov, St. Charles, MO (US); Michael J. Lenger, Bethalto, IL (US)

(73) Assignee: PHILLIPS 66 COMPANY, HOUSTON, TX (US)

(21) Appl. No.: 17/547,529

(22) Filed: Dec. 10, 2021

Related U.S. Application Data
(60) Provisional application No. 63/134,021, filed on Jan. 5, 2021.

(51) Int. Cl. G05B 23/02; G05B 19/418

(52) U.S. Cl. CPC G05B 23/0272; G05B 19/4184; G05B 23/0283

(57) ABSTRACT

A method for optimizing and categorizing equipment diagnostic messages with different steps. The method comprises at least one equipment diagnostic unit which monitors at least one equipment diagnostic message outputted from an equipment during at least a portion of an equipment maintenance workflow. The method also comprises at least one historical database that correlates a historical equipment diagnostic message with an equipment failure database. The method also contains at least one maintenance database that contains information regarding the status of an ongoing maintenance of the equipment and a future maintenance in the equipment maintenance workflow. Finally, the method contains a centralized communication platform wherein the centralized communication platform receives different types of information including at least one equipment diagnostic unit, at least one historical database, and at least one maintenance database. In this method, the centralized communication platform provides information output to at least one equipment operator and wherein the at least one equipment operator is responsible for decision making and overall management of the equipment maintenance workflow.

### CROSS-REFERENCE TO RELATED APPLICATIONS

This application is a non-provisional application which claims the benefit of and priority to U.S. Provisional Application Ser. No. 63/134,021 filed Jan. 5, 2021, entitled “Method for Optimizing and Categorizing Equipment Diagnostic Messages,” which is hereby incorporated by reference in its entirety.

### STATEMENT REGARDING FEDERALLY SPONSORED RESEARCH OR DEVELOPMENT

None.

### FIELD OF THE INVENTION

This invention relates to a method of optimizing and categorizing equipment diagnostic messages.

### BACKGROUND OF THE INVENTION

In recent years, conventional refining processes have experienced a change in with product optimization requirements, efficiency requirements and strict environment-friendly specifications. In petroleum refineries, efficiency is of utmost importance, and every process takes place occurs on enormous scales: fluid flow rates are measured in ton/hour, temperatures are measured in hundred to thousand centigrade degrees and electricity is measured in Megawatts. The slightest system failure or error may cause great damage to the entire facility and to the workers, or at least loss of income. Taking into account all inlet-outlet pipes and various types of measurements (flow rate of water and steam, temperature, pressure, flow rate of fuel oil or combustible gas etc.), the refineries include thousands of sensors.

An effective processing of such data and taking relevant actions in due time is of great importance. It is necessary to constantly monitor, verify accuracy, and determine the effect of the sensor data flowing through a refinery. It has always been a challenge to manage high “volume” and highly “varied” data, and its increased “rate” has become a new problem for the 21^{st} century. The increased importance of the data received from the field and processes has evolved the design of industrial systems such that a large amount of data may be generated. It is now necessary to handle such data properly and then to analyze the data in a reliable manner. In connection with the above, said ever increasing amount of the data volume together with the increased process and technology investment is of great importance for management of petroleum refineries, and it is witnessed that a huge amount of data corresponds to a big problem. In the literature, the issue called as “big data problem” is defined as a high amount of data (i.e. high data load) received from the sensors at high speed and said data has high inconsistency and high variability in terms of data format. Said problems trigger incompatibility and deceleration in decision-making process.

One particular aspect of the big data problem are the sensor data involved in refinery pre-alarm systems. At present refineries are limited to inaccurate predictions of faults based upon warning sensors attached to refinery equipment. The issue lies in the inability for a refinery operator to have all the necessary information in one readily available system so that the operator can made an educated determination what the next steps should be in attending to refinery preventative maintenance, predictive maintenance, corrective maintenance, or reliability centered maintenance.

There exists a need for a method of compiling and analyzing all the data needed for an operator to make an accurate determination of decision making and overall management of the equipment maintenance workflow in a refinery.

### BRIEF SUMMARY OF THE DISCLOSURE

A method for optimizing and categorizing equipment diagnostic messages with different steps. The method comprises at least one equipment diagnostic unit which monitors at least one equipment diagnostic message outputted from an equipment during at least a portion of an equipment maintenance workflow. The method also comprises at least one historical database that correlates a historical equipment diagnostic message with an equipment failure database. The method also contains at least one maintenance database that contains information regarding the status of an ongoing maintenance of the equipment and a future maintenance in the equipment maintenance workflow. Finally, the method contains a centralized communication platform wherein the centralized communication platform receives different types of information including at least one equipment diagnostic unit, at least one historical database, and at least one maintenance database. In this method, the centralized communication platform provides information output to at least one equipment operator and wherein the at least one equipment operator is responsible for decision making and overall management of the equipment maintenance workflow.

In yet another embodiment, the method is described for optimizing and categorizing equipment diagnostic messages with different steps. The method comprises at least one equipment diagnostic unit which monitors at least one equipment diagnostic message outputted from an equipment during at least a portion of an equipment maintenance workflow. The method also comprises at least one historical database that correlates a historical equipment diagnostic message with an equipment failure database. The method also contains at least one maintenance database that contains information regarding the status of an ongoing maintenance of the equipment and a future maintenance in the equipment maintenance workflow. Finally, the method contains a centralized communication platform wherein the centralized communication platform receives different types of information including at least one equipment diagnostic unit, at least one historical database, and at least one maintenance database. In this method, the centralized communication platform provides information output to at least one equipment operator and wherein the at least one equipment operator is responsible for decision making and overall management of the equipment maintenance workflow by prioritizing equipment maintenance within a refinery.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a method for optimizing and categorizing equipment diagnostic messages.

FIG. 2 depicts a method for optimizing and categorizing equipment diagnostic messages.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

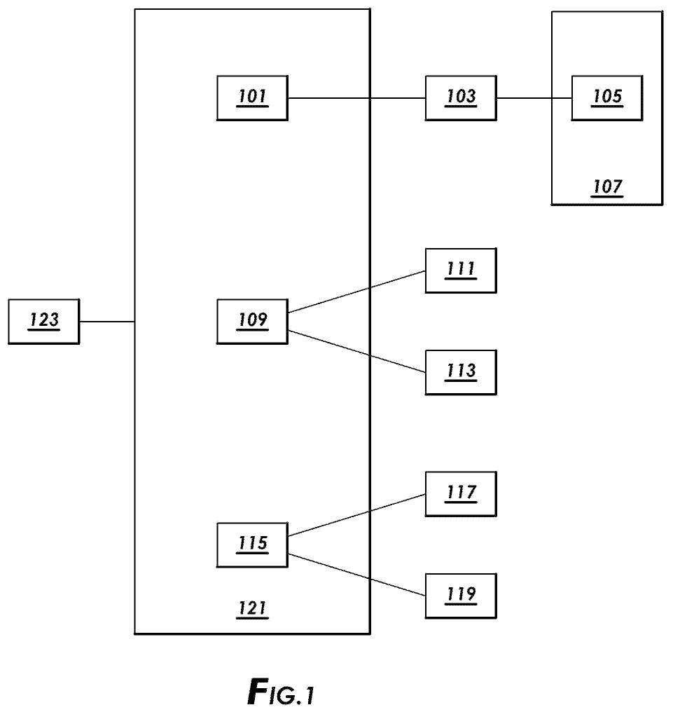

As depicted in FIG. 1, the current method is for optimizing and categorizing equipment diagnostic messages. 101 depicts at least one equipment diagnostic unit which monitors equipment diagnostic messages 103 outputted from an equipment 105 during at least a portion of the equipment maintenance workflow 107. 109 depicts at least one historical database that correlates 111 historical equipment diagnostic messages with 113 an equipment failure database. 115 depicts at least one maintenance database that contains information regarding the status of 117 ongoing maintenance of the equipment and 119 future maintenance in the equipment maintenance workflow. 121 depicts a centralized communication platform wherein the centralized communication platform receives different types of information including at least one equipment diagnostic unit, at least one historical database, and at least one maintenance database. Within the centralized communication platform information is outputted to 123 at least one equipment operator and wherein the at least one equipment operator is responsible for decision making and overall management of the equipment maintenance workflow.

The types of equipment the equipment operator is overseeing in the equipment maintenance workflow include: hydrogen compressor, air blower, wet gas compressor, steam turbine generator, gas turbine generator, hydrogen recycle compressor, make-up hydrogen compressor, air cooler, heat exchanger, reciprocating compressor, cooling water tower, distillation column, accumulator vessel, condenser, separator vessel, coker drum, knock-out pot, reboiler, reactor, PD pump, centrifugal pump, desalter, tanks, boiler, furnace, steam generator, stripper column, and scrubber. These equipment are used to perform a multitude of processes throughout a refinery. Non-limiting examples of different processes that can occur in a refinery include: distilling, isomerization, hydrocracking, power generation, resid hydroprocessing, semi-regen catalytic reforming, steam generation, alkylation, catalytic reforming, fluid coking, catalytic cracking, fluidized catalytic cracking, hydrotreating, hydrogen generation, sulfur recovery, wastewater treatment, maritime loading, blending, asphalt, vacuum flashing, gas plants, viscosity breaker, cracking, reforming, treating, blending, and benzene recovery.

Throughout a refinery an equipment maintenance workflow is needed to perform maintenance items to ensure proper operation of the processes on the equipment. These workflow items can include things such as at least one preventative maintenance check, at least one clean equipment, at least one replace component in equipment, at least one lubricate equipment, and combinations thereof.

In one embodiment, the at least one equipment diagnostic messages from the equipment can consist of messages such as: at least one type of error message, at least one type of equipment failure message, at least one type of equipment maintenance suggestion, at least one no error message, and combinations thereof. In another embodiment, the at least one equipment diagnostic messages can also be messages such as: adjust filter regulator pressure setting, change filter regulator assembly, replace I/P convertor, replace pneumatic relay, replace o-rings, replace printed wiring board, check wiring connections on printed wiring board, adjust or repair feedback linkage, check for air leaks/poor connections, adjust packing to stop leakage, adjust packing to prevent excess friction, replace actuator diaphragm, repair or replace wetted components, calibrate device, install heat tracing, check functionality of heat tracing, install insulation, clear blockages, re-range device, replace transmitter, vent vapors from sensing capsule, seal impulse lines with non-process fluid, replace impulse lines, replace manifold, check loop wiring connections, check proper grounding of shield conductor, adjust threshold setting, replace internal float, verify correct specific gravity, replace internal electronics assembly, lubricate valve stem, verify slop of impulse lines, replace positioner, and combinations thereof.

The number of equipment diagnostic messages that can occur from equipment within a refinery is extremely high. Some pieces of equipment can output over 20,000 messages a day. For an entire refinery and the multitude of equipment, the number of equipment diagnostic messages that an equipment operator must evaluate daily could range from 50,000 to over 400,000 a day. These at least one equipment diagnostic messages can include automated scheduling, at least one automated checklist, or even at least one suggested future maintenance of equipment.

In another embodiment the at least one equipment diagnostic messages can comprise of equipment failures such as power failure, broker/loose wiring connections, incorrect wire polarity, incorrect voltage drop, cable shielding/grounding issues, impulse line plugged/frozen/broken, improper flow characteristics, tubing leak, electronics failure, sensor failure, device temperature limits exceeded, calibration failure, positioner failure, loop current saturated/fixed, communication failure, valve travel deviation, sensor outside predefined limits, supply pressure failure, supply pressure leak, corroded wiring water intrusion, relay failure, regulator failure, float failure, reverse flow detected, pneumatic problem, high friction, high signal noise, or even battery failure.

In one embodiment of this method contains at least one historical database that correlates a historical equipment diagnostic message with an equipment failure database. The historical equipment diagnostic message can comprise of all the different types of historical equipment diagnostic messages as listed above. The equipment failure database can consist of failures such as: at least one operating at non-optimal conditions, at least one operating but failure imminent, at least one operating but environmental risk, and combinations thereof.

By reviewing the outputs of the at least one equipment diagnostic unit, at least one historical database, and at least one maintenance database in the centralized communication platform the equipment operator is able to optimize the different processes that occur within a refinery. The equipment operator would be able to modify the equipment maintenance workflow by prioritizing maintenance to critical operating equipment within a refinery. Different ways that the equipment operator would be able to do this include adding equipment to the equipment maintenance workflow, removing equipment from the equipment maintenance workflow, adding maintenance items to the equipment maintenance workflow for a particular piece of equipment, removing maintenance items from the equipment maintenance workflow for a particular piece of equipment, and prioritizing the equipment maintenance workflow by reviewing the centralized communication platform.

In another embodiment, the equipment operator is able to add or remove equipment to the equipment maintenance workflow by determining if the equipment affected by the equipment diagnostic messages are on the equipment maintenance workflow.

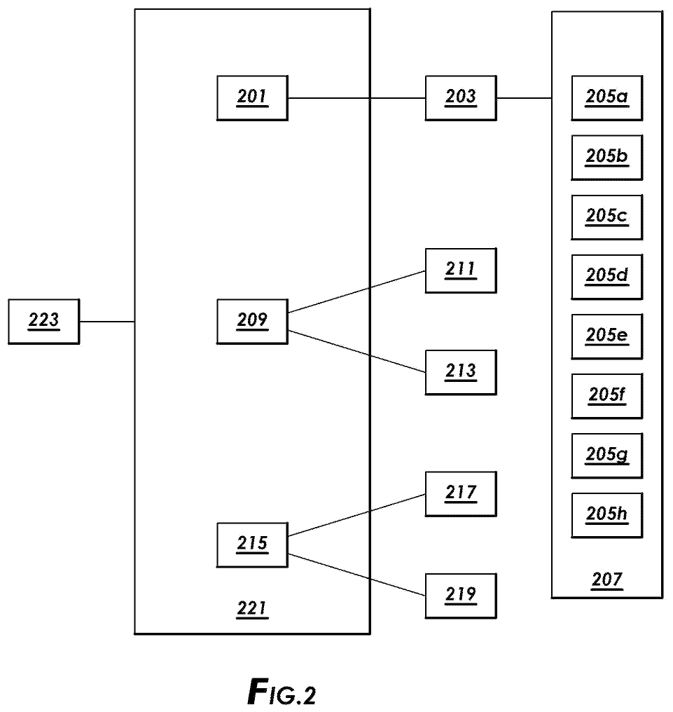

In an alternate embodiment, as depicted in FIG. 2, the method is for optimizing and categorizing equipment diagnostic messages. 201 depicts at least one equipment diagnostic unit which monitors equipment diagnostic messages 203 outputted from an equipment 205a during at least a portion of the equipment maintenance workflow 207.

In this embodiment, the equipment diagnostic messages can also occur from 205b control system alarm designations. These messages define which instruments with diagnostic messages have alarms associated with the equipment. In another embodiment, the equipment diagnostic messages can also occur from 205c control system instrument descriptions. These messages can describe the particular task the equipment is currently performing. In another embodiment, the equipment diagnostic messages can also occur from 205d control system control/indicator configuration. These messages define whether a particular piece of equipment is associated with automated control or if they are only for indication of equipment. In another embodiment, the equipment diagnostic messages can also occur from 205e instrument location/area of responsibility. These messages can define where a particular piece of equipment is located. In another embodiment, the equipment diagnostic messages can also occur from 205f maintenance information. These messages can track the maintenance status of a particular piece of equipment. In another embodiment, the equipment diagnostic messages can also occur from 205g weather information. These messages can track weather related issues such as rainfall, temperature, and humidity. In another embodiment, the equipment diagnostic messages can also occur from 205h process information. These messages can track the process information associated with each instrument, such as valve position, controller output, process valves etc.

209 depicts at least one historical database that correlates 211 historical equipment diagnostic messages with 213 an equipment failure database. 215 depicts at least one maintenance database that contains information regarding the status of 217 ongoing maintenance of the equipment and 219 future maintenance in the equipment maintenance workflow. 221 depicts a centralized communication platform wherein the centralized communication platform receives different types of information including at least one equipment diagnostic unit, at least one historical database, and at least one maintenance database. Within the centralized communication platform information is outputted to 223 at least one equipment operator and wherein the at least one equipment operator is responsible for decision making and overall management of the equipment maintenance workflow.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method for optimizing and categorizing equipment diagnostic messages, comprising the steps of:
at least one equipment diagnostic unit which monitors at least one equipment diagnostic message outputted from an equipment during at least a portion of an equipment maintenance workflow;
at least one historical database that correlates a historical equipment diagnostic message with an equipment failure database;
at least one maintenance database that contains information regarding the status of an ongoing maintenance of the equipment and a future maintenance in the equipment maintenance workflow;
a centralized communication platform wherein the centralized communication platform receives different types of information including at least one equipment diagnostic unit, at least one historical database, and at least one maintenance database; and
wherein the centralized communication platform provides information output to at least one equipment operator and wherein the at least one equipment operator is responsible for decision making and overall management of the equipment maintenance workflow.

2. The method of claim 1, wherein the at least one equipment diagnostic messages comprise at least automated scheduling.

3. The method of claim 1, wherein the at least one equipment diagnostic messages comprise at least one automated checklist.

4. The method of claim 1, wherein the at least one equipment diagnostic messages comprise at least one suggested future maintenance of the equipment.

5. The method of claim 1, wherein the at least one equipment diagnostic messages consisting of messages such as: at least one type of error message, at least one type of equipment failure message, at least one type of equipment maintenance suggestion, at least one no error message, and combinations thereof.

6. The method of claim 1, wherein the equipment maintenance workflow consisting of maintenance workflow items such as: at least one preventative maintenance check, at least one clean equipment, at least one replace component in equipment, at least one lubricate equipment, and combinations thereof.

7. The method of claim 1, wherein the equipment failure database consisting of failures such as: at least one operating at non-optimal conditions, at least one operating but failure imminent, at least one operating but environmental risk, and combinations thereof.

8. The method of claim 1, wherein the at least one equipment operator is able to add equipment to the equipment maintenance workflow by determining if the equipment affected by the equipment diagnostic messages are on the equipment maintenance workflow.

9. The method of claim 1, wherein the at least one equipment operator is able to remove equipment on the equipment maintenance workflow by determining if the equipment affected by the equipment diagnostic messages are on the equipment maintenance workflow.

10. The method of claim 1, wherein the at least one equipment operator is able to prioritize the equipment maintenance workflow by reviewing the centralized communication platform.

11. A method for optimizing and categorizing equipment diagnostic messages, comprising the steps of:
at least one equipment diagnostic unit which monitors at least one equipment diagnostic message outputted from an equipment during at least a portion of an equipment maintenance workflow;
at least one historical database that correlates a historical equipment diagnostic message with an equipment failure database;
at least one maintenance database that contains information regarding the status of an ongoing maintenance of the equipment and a future maintenance in the equipment maintenance workflow;
a centralized communication platform wherein the centralized communication platform receives different types of information including at least one equipment diagnostic unit, at least one historical database, and at least one maintenance database; and
wherein the centralized communication platform provides information output to at least one equipment operator and wherein the at least one equipment operator is responsible for decision making and overall management of the equipment maintenance workflow by prioritizing equipment maintenance within a refinery.

12. The method of claim 1, wherein prioritizing equipment maintenance is performed by prioritizing maintenance to certain equipment over others within a refinery.

13. The method of claim 1, wherein prioritizing equipment maintenance is performed by prioritizing maintenance in an equipment maintenance workflow.
